(19) United States
(12) Patent Application Publication
(10) Pub. No.: US 2013/0079933 A1
(43) Pub. Date: Mar. 28, 2013

(54) CIRCUMVENTING FREQUENCY EXCITATIONS IN A COMPUTER SYSTEM

(71) Applicants: Cheng P. TAN, Fremont, CA (US); Anthony J. Aiello, Santa Cruz, CA (US); Brad Lee Patton, Campbell, CA (US); Con D. Phan, Milpitas, CA (US); Jesse T. Dybenko, Cupertino, CA (US); Thomas W. Wilson, JR., Saratoga, CA (US)

(72) Inventors: Cheng P. TAN, Fremont, CA (US); Anthony J. Aiello, Santa Cruz, CA (US); Brad Lee Patton, Campbell, CA (US); Con D. Phan, Milpitas, CA (US); Jesse T. Dybenko, Cupertino, CA (US); Thomas W. Wilson, JR., Saratoga, CA (US)

(73) Assignee: Apple Inc., Cupertino, CA (US)

(21) Appl. No.: 13/354,211

(22) Filed: Jan. 19, 2012

Related U.S. Application Data
(60) Provisional application No. 61/460,772, filed on Sep. 23, 2011.

(51) Int. Cl. G05B 23/02

(52) U.S. Cl. 700/280

(57) ABSTRACT

The described embodiments relate generally to control of rotational components in a computer system. In one embodiment, the rotational component includes a cooling fan assembly, the cooling fan assembly being controlled in accordance with resonant frequency avoidance data. The resonant frequency avoidance data being characteristic of the computer system such that when the cooling fan assembly operates in accordance with the resonant frequency avoidance data, the cooling fan assembly does not operate at a fan speed that is coincident with a natural resonant frequency of the computer system.

### FIELD OF THE DESCRIBED EMBODIMENTS

The described embodiments relate generally to reducing rotation induced vibrations from associated components in computing systems. In particular, a method and system to avoid operating the components at rotational speeds that can coincide with resonant frequencies of the computer system are described.

### RELATED ART

One common way to facilitate heat removal from computers is to introduce cooling fans that circulate air into and out of a computer enclosure. Cooling fans were originally designed to simply run the entire time the computer was on. While this made for a predictable, and continuous operating state, it was not energy efficient and resulted in the creation of unnecessary noise and vibrations. In a slightly more advanced configuration, the fan could be switched between on and off states whenever the internal temperature of the computer enclosure exceeded a certain threshold temperature. Further innovations brought Pulse Width Modulation (PWM) control to cooling fans. PWM controllers change the speed of direct current (“DC”) cooling fan motors by modulating the input voltage, which may be represented as a periodic rectangular wave having an alternating sequence of on-time and off-time. The fraction of time that the signal is active equates to the duty cycle of the PWM signal. For example, where the on-time pulse duration (t) is 0.5 seconds and the period (T) of the PWM signal is 1 second, the duty cycle is 50 percent. In this way, fan speed can be modulated between a numbers of speeds which allows a cooling system to more efficiently regulate the internal temperature of a computer system. At low enough rotational speeds a fan might not even be noticeable to the end user of a computer system. While the speed modulation capability allowed by PWM controllers does allow cooling to take place much more efficiently, the high number of different potential frequencies greatly increases the possibility of at least one cooling fan operating speed having a vibration resonance which coincides with a resonant frequency of the structure of the computer system. When these vibration resonances coincide, vibrations can become significantly more pronounced, causing distracting noise and vibration to propagate through the computer enclosure.

Therefore, what is desired is a reliable way to identify and avoid those operating conditions where a system resonance frequency and vibration resonance coincide to produce mechanical vibrations that adversely affect the overall user experience.

### SUMMARY OF THE DESCRIBED EMBODIMENTS

This paper describes various embodiments that relate to a computing system having mechanical components, some of which have rotational aspects with vibration resonances. Methods and apparatus for preventing the coincidence of a vibration resonance and a system resonance are described.

A method for operating a computing system having at least one mechanical component having a rotational aspect controlled by a processor is described. In one embodiment, prior to operating the mechanical component with the rotational aspect at a first operating state, it is determined if the first operating state coincides with a resonant frequency of the computing system. When it is determined that the first operating state does coincide with the resonant frequency, then modifying the first operating state of the mechanical component to a second operating state that avoids the resonant frequency of the computing system.

In one aspect of the described embodiment, determining if the first operating state results in the mechanical component having a vibration resonance that coincides with a resonance frequency of the computing system is carried out by a sensor monitoring the physical response of the computing system. If the monitored physical response is greater than a threshold level, then the first operating state is determined to coincide with the resonant frequency of the computing system. The operating state is then avoided during operation of the computing system in the second operating state.

A computing system is described that includes a data storage device for storing data, at least one mechanical component having a rotational aspect and a processor. In the described embodiment, during operation of the computing system, the processor dynamically determines a critical resonance frequency for the at least one mechanical component using a sensor by progressively changing a rotational speed of the rotational aspect of the mechanical component through a range of rotational speeds, using the sensor to monitor a mechanical response of the computing system while the rotational speed is being progressively changed, identifying the rotational speed as a resonant rotational speed when the mechanical response monitored by the sensor exceeds a pre-determined threshold, and storing the resonant rotational speed in the data storage device as, for example, a Look Up Table (LUT). In one aspect of the embodiment, the sensor is disposed within the computing system. In another aspect, the sensor is disposed external to the computing system.

Non-transient computer readable medium for storing computer code executable by a processor in a computer system having at least one mechanical component having a rotational aspect is described. The computer system includes at least one sensor arranged to detect a mechanical vibration of the computer system and a data storage device. The computer readable medium includes computer code for progressively changing a current rotational speed of the rotational aspect of the mechanical component through a range of rotational speeds. Computer code for continuously monitoring by the at least one sensor a physical response of the computer system to the current rotational speed. Computer code for identifying the rotational speed of the rotational aspect as a resonant speed at which the physical response of the computer system exceeds a pre-determined threshold level of physical response. The non-transient computer readable medium also includes code for storing the resonant rotational speed in a data storage device in the computer system. In one aspect of the described embodiment, the resonant rotational speed is embodied as data in a Look Up Table (LUT). In one aspect, the mechanical component is a fan assembly and the rotational aspect is a fan blade/rotor assembly.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows a system diagram with the various components used to drive a cooling fan.

FIG. 2 shows a Campbell Diagram summarizing the vibration resonances vs. rotational speed for a cooling fan.

FIG. 3 shows a cross sectional view of a cooling fan in accordance with the described embodiments.

FIG. 4 shows a graph which explains how the fan controller can alter the fan speed of a cooling fan to avoid resonant frequencies of a computer system in accordance with the described embodiments.

FIG. 5 shows the vibration producing bodies of an exemplary computer system in accordance with the described embodiments.

FIG. 6 shows a flow chart detailing one way for instituting the described embodiment on a computer system from design to operation.

FIG. 7 shows a flow chart describing a process in accordance with the described embodiments.

FIG. 8 shows a flow chart describing a process in accordance with the described embodiments.

### DETAILED DESCRIPTION OF EXAMPLE EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting. Accordingly, other embodiments may be used and changes may be made without departing from the spirit and scope of the described embodiments.

Computer systems generally incorporate a number of components, some of which can include rotational aspects (such as fan rotors with blades) that can generate unwanted noise and vibration. Components such as optical disc drives (ODD), hard disk drives (HDD) and cooling fans are examples of such components. Cooling fans, in particular, are one of the leading causes of noise and vibrations in modern computer systems. When these cooling fans are driven at a number of different speeds, it becomes increasingly likely that they can generate a vibration at a frequency that has the potential to coincide with a resonant frequency of the computer system. This coincidence can result in noticeable physical response that can manifest as a buzzing sound, noticeable vibration, or in some cases can adversely affect operation of other mechanical components. For example, a sufficiently severe vibration can adversely affect the operation of a hard disk drive (HDD) that relies upon a read/write head to access data stored in a rotating data storage medium.

Obtaining a reliable and accurate vibration profile of the computer system as to the number and location of resonant frequencies can be quite difficult due to, for example, system to system variation and manufacturing tolerances, as well as a potentially large number of different sources of vibration. To further complicate matters, a vibration profile of the computer system can be altered from an original version in many ways. For example, the vibration profile of the computer system can be altered when an end-user modifies the computer system after production. Components can be added to (or removed from) a standard configuration resulting in a number of different configurations each potentially having significantly different vibration profiles, thus making it difficult to provide a reliable list of resonant frequencies that can be used to characterize the behavior of a particular computer system. Furthermore, vibration profiles can be altered due to changes in operational characteristics of the various components due to normal wear and tear, operational upsets such as dropping, changes due to thermal cycling, and so forth. These factors along with tolerance and mounting variation can make it quite difficult to arrive at a list of resonant frequencies that can be relied upon to prevent a component having a rotational aspect from operating coincident with a system resonant frequency.

Unfortunately, however, accurate identification of the resonant frequencies can require analysis that can be quite lengthy and complex especially when there is more than one source of vibration in the computer system. For example, in addition to a cooling fan (or fans), other sources of vibration such as the HDD and/or ODD can interact with each other resulting in a complex physical response that may be very different than a response from a single vibration source. Moreover, the vibrations produced by each of the different operating components can be directly related to a current operating state of the computer system thereby adding additional complexity. For example, during a data read operation, both the HDD and the ODD can be vibration sources. However, during a data write operation, only the HDD can remain as a vibration source (the ODD being placed in stand-by mode).

In order to overcome these obstacles, a testing regime can require at least cycling the cooling fans (or other operational components having rotational aspects) through most or all potential operating modes and speeds in combination with each and every other source of vibration in the computer system. In this way, vibration profiles can be generated for any number of combinations of operating components. For example, the various vibration profiles can reflect operating conditions where with the HDD and ODD are operating (or only one or the other is operating) and so forth. Once a resonant frequency is identified, in a procedure referred to as notching, a controller circuit (such as a fan controller) can direct the associated component to operate in an operating state just above or below the identified resonant frequency if that frequency would otherwise have been selected. For example, when it is determined that a cooling fan assembly operating at a fan speed FS1 coincides with a system resonant frequency (based upon a monitored physical response of the computer system), the cooling fan assembly can be directed to avoid fan speed FS1. In one embodiment, the fan speed FS1 can be “notched” out, or removed, from the operating regime of the cooling fan assembly. By notched out, it is meant that in those situations that would otherwise call for the cooling fan assembly to operate at fan speed FS1, cooling fan assembly would be directed to operate at fan speeds other than fan speed FS1. For example, the cooling fan assembly can be directed to operate at fan speed FS2 where fan speed FS2 has been determined to not coincide with a system resonant frequency. In some cases, fan speed FS2 can be greater than fan speed FS1 in order to avoid any possibility of under-cooling the computer system. However, it should be noted that in order to preserve power, fan speed FS2 can be less than fan speed FS1 when it is determined that this operating state will maintain proper cooling of the computer system. In this way, by operating fan speed FS2 that is less (i.e., slower) than FS1, the cooling fan assembly can operate at a reduced power thereby preserving power resources.

It should be noted that while computer system calibration could be quite effective at establishing a good baseline for operation of the computer system components that act as vibration sources, the physical response of the computer system can change for a number of reasons in addition to an end-user modification discussed above. For example, the response of the computer system (also referred to as the vibration profile) can change due to normal wear of mechanical components of the computer system (i.e., rotational components begin to wear out or the effectiveness of lubrication wanes), thermo-mechanical changes (expansion or contraction) due to variation in temperature, pressure, humidity, and so forth. Each of these environmental factors can be included in the stored data and be used to modify the operating state in accordance with an appropriate environmental factor.

More specifically, operational characteristics of mechanical components tend to change over time. For example, a cooling fan can operate at slightly different speeds than originally designed due to, for example, wearing of components, breakdown of lubrication, and so forth. These changes can have the effect of shifting the performance curve of the mechanical component. In some cases, this shift in the performance curve cannot be easily predicted. For at least this reason, a vibration profile that takes into consideration time and wear characteristics of a particular system can be very desirable. In this way, periodically updating the vibration profile of the computer system can be very useful. The updating can be performed manually by an end-user, the updating can be performed by the end-user when prompted by the computer system, or the updating can be performed automatically as determined by the computer system. In any case, the updating of the vibration profiles can greatly enhance the end-user's overall enjoyment of the computer system.

Many computer systems include sensors that can be used to detect and monitor physical reactions of a computer system. These sensors can rely upon mechanical changes in the computer system that can be detected and recorded. In one embodiment, an integrated microphone can be used to detect the auditory noise produced by the vibrations. In another embodiment, a motion or acceleration based sensor (such as a G sensor or an accelerometer) can be utilized for detecting the vibrations. In still other embodiments, the sensors can be bench test type sensors that can be used to create a baseline vibration profile for a representative computer system that can then be stored locally in a data storage device in the computer system. For example, using one or more sensors while operating the fan(s) in a range of expected fan speeds, a vibration profile for the computer system can be created. In one embodiment, the sensors can be part of the bench test environment. In some cases, however, the motion sensors can include sensors incorporated into the computer system (referred to as on-board sensors). In this way, the vibration profile for a particular computer system can be periodically updated using real time data from the on-board sensors.

In any case, it should be noted that when relying upon the sensors, any extrinsic source (i.e., not related to the computer system) of vibration or acceleration should be minimized or at least characterized in order to provide a vibration profile that is as close to the actual operation of the computer system as possible. For example, ambient noise could potentially interfere with an acoustic sensor such as a microphone accurately monitoring acoustic signals from the computer system. Characterizing the physical response of the computer system at an elevated temperature could provide a vibration profile that is substantially different than the vibration profile when the computer system is operating at a lower temperature (due in part to expansion/contraction of components). Therefore, providing vibration profiles at different temperatures is especially useful when the computer system has components that are particularly susceptible to physical changes (such as expansion and contraction) due to temperature, pressure, humidity, and so on. For example, during an assembly process, the physical responses of the computing device can be characterized for resonant frequency interactions using any number and type of external and internal sensors. The computing system can be identified and the resonant frequencies can be stored locally as part of a set of operating data used in the operation of the computing device

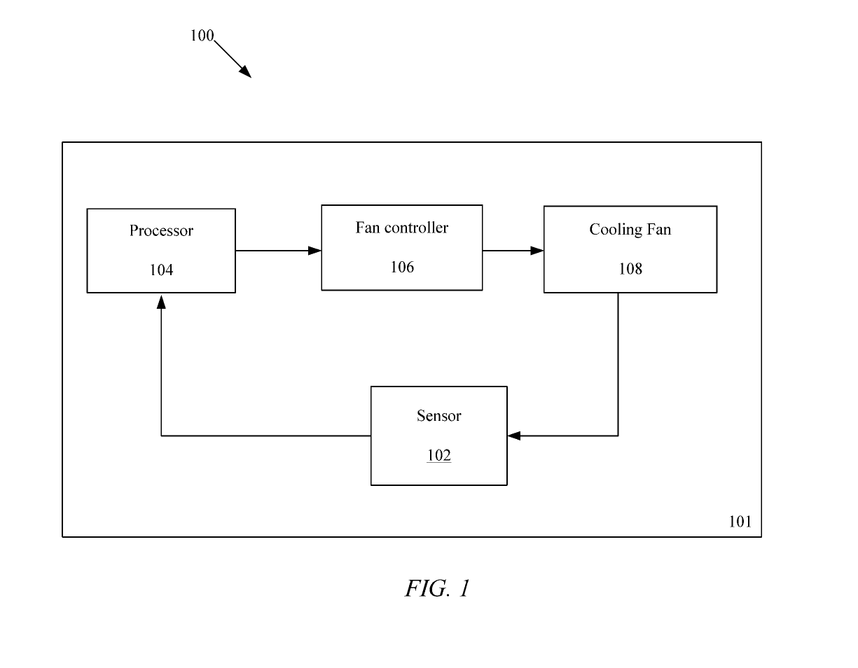

FIG. 1 shows computer system 100 in accordance with the described embodiments. Computer system 100 includes at least computer system enclosure 101 that, in turn, includes at least one temperature sensor 102. Temperature sensor 102 can alert processor 104 when computer system enclosure 101 has exceeded a certain threshold temperature value. Fan controller 106 can be used to drive at least one cooling fan 108 at a particular fan speed. In one embodiment, fan controller 106 can take the form of a Pulse Width Modulation (PWM) controller 106. In any case, fan controller 106 can be directed by processor 104 configured to operate on data stored in a local memory device. The data that can be used by processor 104 can include resonance avoidance data. The resonance avoidance data can be used to direct fan controller 106 to drive cooling fan 108 at a fan speed that avoids a known system resonance. The resonance avoidance data can be embodied as a Look Up Table (LUT) stored in the local memory device. The resonance avoidance data in the LUT can be updated as needed. For example, the resonance avoidance data can be updated to take into account changes in the operating state of the computer system. The changes in the operating state of the computer system can include, for example, operation of multiple vibration sources such as an HDD and an ODD. The changes in the operating state of the computer system can also include lower power operation when battery charge is low or operating in an increased power mode when the battery is fully charged or the computer system is coupled to an external power supply. Changes in environmental factors such as temperature, pressure, and age-related wear and tear, can also be used in conjunction with the data to alter the operating state of the computer system.

When fan controller 106 takes the form of a PWM controller, adjustment of the speed of cooling fan 108 can be accomplished by varying the duty cycle of the signal provided to cooling fan 108. Once cooling fan 108 reduces the internal temperature of computer system enclosure 101, sensor 102 can detect a current temperature within computer system enclosure 101. The controller can also be designed to adjust the operating state of other components in the computer system that have an impact on temperature. If the current temperature is determined to be within an acceptable range of operating temperatures, processor 104 can direct PWM controller 106 to maintain or reduce the speed of cooling fan 108. In this way, the feedback loop between sensor 102 and PWM controller 106 can result in a large number of potential operating states of the fan assembly. Each of these potential operating states must be evaluated for potential coincidence with system resonance frequencies. In addition to variation of the rotational speed of cooling fan 108, when multiple potential vibration sources are present, the computer system can exhibit multiple vibration profiles depending upon the number of and current operating state of each of the multiple vibration sources. In this way, the resonance avoidance data can be related to a single component, such as cooling fan 108, or can be related to multiple components (such as the HDD and ODD) that can operate at the same time as fan assembly 108 under varying operating conditions.

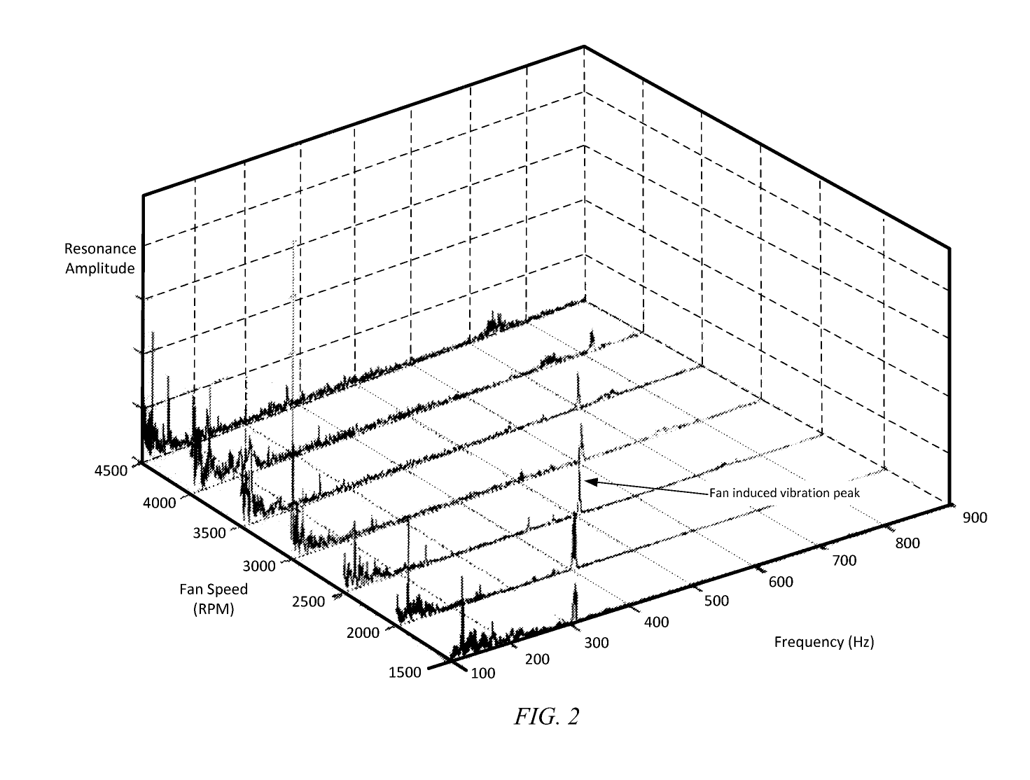

In FIG. 2, a Campbell Diagram is shown. A Campbell Diagram is used to evaluate vibration resonances for a rotating body at a number of different rotational speeds. The Campbell Diagram shown in FIG. 2 indicates that as the rotational speed of a cooling fan speed increases, the frequency of the associated vibration modes also increases. By using the data contained in the Campbell diagram, it is possible to predict those rotational fan speeds at which characteristic vibration frequencies of the fan coincide with the natural vibration resonances of a computer system. In a procedure referred to as notching, data provided by the Campbell Diagram contains information that can be used to set the rotational fan speed of a fan assembly to a value such that fan-induced vibration frequencies do not coincide with any natural vibration resonances of the system to which the fan assembly is attached. For example, if the computer system has a vibration resonance at 510 Hz, then it will coincide with the 510 Hz vibration spike induced by the fan when operating at 2500 RPM. Therefore, in order to avoid the vibration resonance at 510 Hz, the fan speed of the cooling fan is set to a value greater (or less) than 2500 RPM.

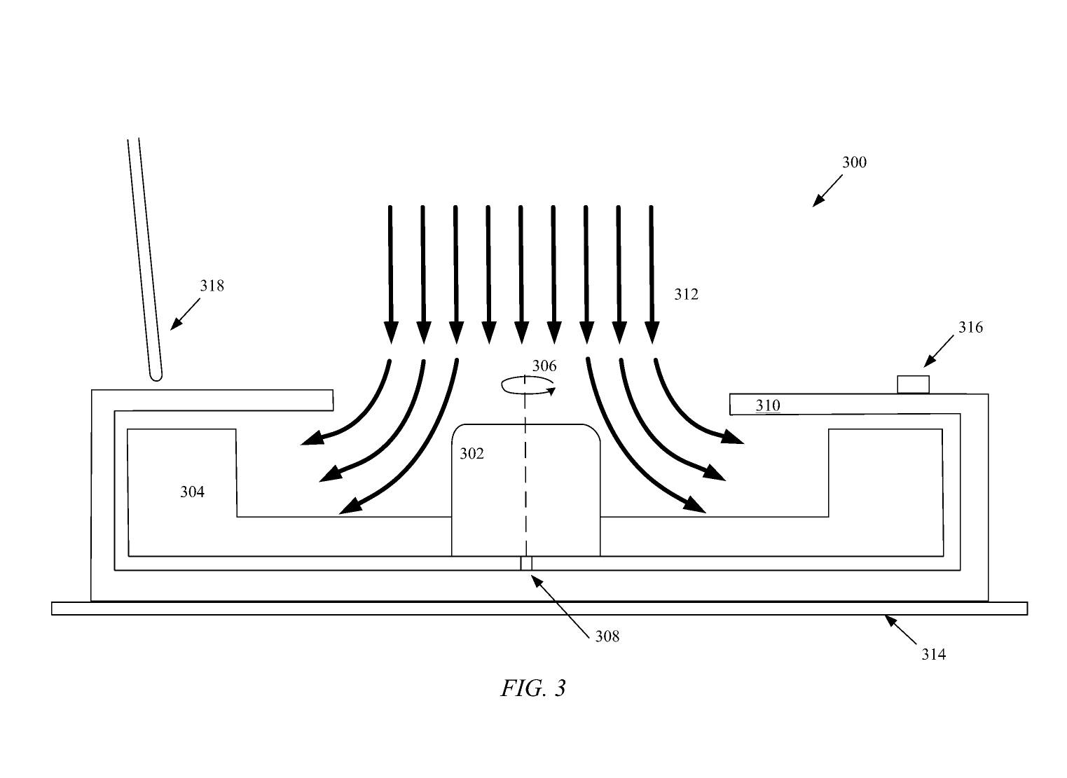

FIG. 3 shows a cross sectional side view of cooling fan assembly 300 in accordance with the described embodiments. When a voltage is applied to cooling fan assembly 300, hub 302 having attached fan blades 304 rotates about axis 306 by way of driving mechanism 308. Fan housing 310 that surrounds and encloses the fan components generally provides both an entrance and exit for air stream 312. Subsequent to mounting cooling fan assembly 300 to computer system 100 (but prior to closing the computer system enclosure 101), sensors can be used to characterize various operating states of cooling fan assembly 300 and corresponding physical responses of computer system 100. For example, the sensors can include motion sensors such as accelerometer 316 and vibration sensing laser 318 that can be used to detect various vibration resonances of the computer system. It should be noted, however, that the position of the sensors in relation to cooling fan assembly 300 and within computer system 100 can be varied in order to capture as many of the vibration resonances of the computer system as possible.

For example, portions of cooling fan assembly 300 that are most sensitive to vibration can be identified for assembly line testing. This information can then be used to ascertain an optimal calibration testing arrangement. Bench calibration testing can include vibration sensing laser 318 and accelerometer 316 that can be used to obtain precise readings for various vibration resonances that otherwise would be difficult for a less sensitive on-board sensor to capture in follow-on recalibrations. In one embodiment, the vibration resonance information can be stored for later use. For example, the vibration resonance information can take the form of a Look Up Table, or LUT, that can be stored in a data storage device such as a non-volatile memory in communication with a processor used to control operations of computer system 100. In this way, the processor can use the information in the Look Up Table to provide operating instructions to a fan controller used to modify the operation of fan assembly 300. In this way, the initial calibration information can be used over an extended period of time.

In one embodiment, various on-board sensors can be used to monitor any changes from the expected response of computer system 100 to a current operating state of cooling fan assembly 300. Having on-board sensors is particularly useful in monitoring any changes in the responses of computer system 100 over the operating life of computer system 100. Periodic updating of the calibration information stored in the data storage device can be carried out either automatically (at pre-determined intervals of operation) or by an end-user calling for a re-calibration procedure. The re-calibration procedure can be based upon the end-user initiating the re-calibration procedure by interacting with an appropriate user interface (i.e. through a trouble shooting menu). The recalibration procedure can then cause cooling fan assembly 300 to operate at various operating states (i.e., varying fan speed, for example) concurrent with an on-board sensor monitoring a corresponding physical response of computer system 100. The monitored physical response of computer system 100 can then be compared to the baseline (or initial) physical response obtained in a factory setting (or at a previous re-calibration). If the comparison indicates a difference in physical response for a given cooling fan assembly operating state greater than a threshold value, then the calibration data stored in the data storage device can be updated with the most recent calibration information. In some cases, if the difference in physical response is greater than a second threshold indicating system response is not acceptable (possibly indicative of a mechanical problem such as a loose fitting or coupling), a notice to the end-user can be provided, indicating that service by an authorized service center may be required.

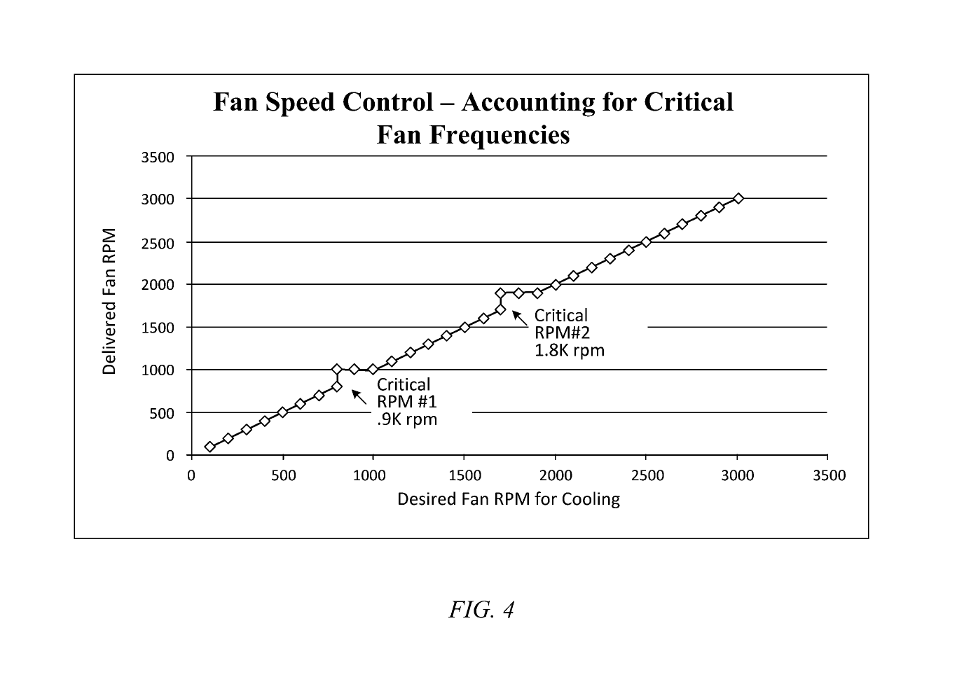

FIG. 4 is a graph showing how the PWM controller can be designed to help the cooling fans avoid a computer system's resonant frequencies. The graph shows a first critical fan speed at 900 RPM and a second critical fan speed at 1,800 RPM. A critical fan speed is defined as a speed at which the fan has a vibration mode frequency that is proportional to the fan speed and is coincident with a system resonance frequency. Each of the critical fan speeds corresponds to a vibration mode frequency which is positioned well within human decipherable frequency range of 20 Hz to 20 kHz and would be quite noticeable to a user of the computer system. When the conditions within the computer (e.g., high operating temperature) require the fan assembly to operate at a fan speed that results in fan vibration modes being coincident with system vibration resonances, the processor can direct the fan assembly to operate at a fan speed that is outside of the range of known critical fan speeds. For example, the processor can direct the fan assembly to operate at a fan speed that is greater than the resonant fan speed, rather than below the resonant fan speed in order to avoid under-cooling the computer system. In this way, a situation where temperature sensitive components in the computer system are likely to overheat and potentially degrade in performance or even over time fail can be avoided.

It should be noted that the width of the frequency response can determine an amount above (or below) the resonant frequency that the cooling fan is directed to operate. In some cases the cooling fan may be directed to operate at a fan speed that is about 50-100 Hz above (or below) a resonant frequency having a relatively narrow width. However, for those resonant frequencies having a somewhat broader width, a slightly larger buffer may be necessary. In addition to variations in the width of the frequency response, an additional guard band may be prudent in those cases where the heat of the computer system can cause small variations in the values of the resonant frequencies and thereby affect their respective widths. It should be noted, however, that in most cases this additional guard band is generally no more than about 10-20 Hz.

In those cases where a computer system has components that are susceptible to changes in temperature, more than one set of calibration data embodied in, for example, the Look Up Table can be provided depending on the range of temperatures at which the computer system is currently operating. For example, if it is determined that a particular component in the computer system has a system resonance at a temperature T1, and then it may be prudent to provide temperature dependent operational instructions to that component when the temperature of the component approaches the temperature T1. For example, if an ODD has an operating state that has been characterized as being associated with a system resonance at disk speed S1 at temperature T1, then a Look Up Table specific to the ODD can provide data for the processor to direct the HDD to spin at a somewhat different RPM than it would otherwise. Moreover, another Look Up Table can be provided for another component (such as an HDD) or even for the ODD at another temperature. Again, the computer system can be calibrated as a function of a single component, or multiple components separately or in combination described in more detail below.

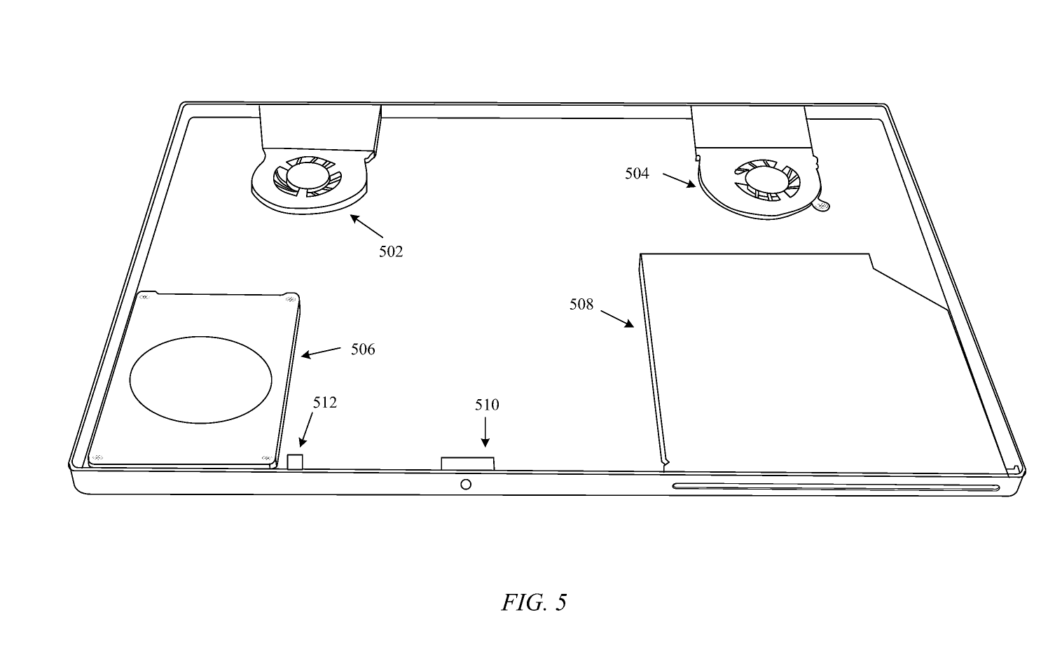

FIG. 5 shows computer system 500 that includes a number of sources of vibration such as cooling fans, ODD, HDD, and so forth. Although computer system 500 can take many forms, for the present discussion and without loss of generality, computer system 500 takes the form of a portable computer such as a laptop. In particular, FIG. 5 illustrates a situation where multiple sources of vibration can interact in such a way that a more complex vibration profile or even a set of vibration profiles can be required to adequately characterize the vibration resonances of the computer system. For example, multiple sources of vibration can interact with each other (by constructive and/or destructive interference) producing what is referred to in acoustics as beating. More specifically, the frequencies of the various vibration sources can interfere with each other to create a vibration having a beating frequency. This combined vibration can vary with the operating state of the computer. For example, the combined vibration can vary when the HDD spins up to store or retrieve data, or an optical disk in the ODD spins up or down, or when a cooling fan assembly spins up or down in response to a cooling requirement. The dynamic nature of changes in the operating state of the laptop computer can require multiple sets of operating data for each of the sources of vibration. For example, in one embodiment, the multiple sets of operating data can be embodied in a single multi-component Look Up Table or in some cases multiple component Look Up Tables can be stored in a memory device accessible by a processor in the laptop computer. The processor can use the operating data to vary the operation of the various sources of vibration, either singly or in combination, to maintain an acceptable user experience under all, or at least most, operating states of the laptop.

Computer system 500 in the form of laptop 500 can include a number of components each of which can individually become a vibration source independent of each other or in some situations as a result the operation of other components (such as a cooling fan spinning up to remove excess heat generated by an HDD or ODD). For this example, laptop 500 can include a cooling system embodied as cooling fan 502 and cooling fan 504 whereas a data system can be embodied as HDD 506 and ODD 508 each of which can operate independent of or in conjunction with each other. For example, HDD 506 can access a large amount of stored data by rapidly rotating a disk concurrent with a cooling fan(s) changing fan speed(s) in order to maintain a proper operating temperature of the computer system. In order to obtain an accurate Look Up Table for a system of this sort, each contributing source of vibration should be operated simultaneously, as they might during regular computing operations. One possible scenario could include cycling each cooling fan slowly through its range of speeds, while the other components operate in various operating states. For example while cooling fan 502 cycles through its numerous possible operating speeds, cooling fan 504 can be set at a speed of 2500 RPM, HDD 506 spins at 5400 RPM and ODD 508 spins at 5000 RPM. As discussed above, beating frequencies can develop when two (or more) vibrating or rotating bodies are operated at similar but not quite the same frequency. Therefore, in order to avoid generating beating frequencies when more than one vibration source is present, additional data can be provided indicating operation conditions that can lead to the generation of a beating frequency. For example, data associated with cooling fan 502 and cooling fan 504 can be provided for access by the processor when both fans are operating, raising the possibility of generating a beating frequency. In order to reduce this possibility, the fan speeds of cooling fan 502 and 504 can be altered in such a way that a beating frequency is generally avoided.

In some situations, it may be desirable to recalibrate the physical response of laptop 500. For example, if a first calibration has been performed using motion vibration detectors during which an extraneous vibration source unrelated to the physical response of the laptop has been introduced, the resulting calibration data can be less than optimal. Therefore, in some situations it can be desirable to perform multiple calibration tests in order to affirm the results of the first calibration test. If the calibration data of the first and second calibration tests match within an acceptable tolerance, then the calibration data can be stored in a memory device either on-board the laptop and/or in an external testing device, otherwise the calibration should be redone.

In another example where an acoustic detection mechanism, such as microphone 510, is used to characterize the physical response of the laptop computer, a test location having little ambient noise should be selected to prevent erroneous readings. One way to do this would be for microphone 510 to sample the ambient noise level prior to initiating the calibration procedure. In this way accurate data can be more reliably obtained. Furthermore, any external ambient noise in the test environment (such as a door closing shut) during a calibration can be grounds for re-starting the calibration. A second sampling could be accomplished at the end of the calibration in order to characterize any change in ambient noise levels during the calibration process. Any changes in the ambient noise can be accounted for in the acoustic calibration data prior to being stored in a memory device for later use in modifying the operation of the laptop.

In another embodiment, an end-user can initiate a calibration procedure. In one embodiment, the end-user can take advantage of a user interface that can include, for example, a menu of selectable items at least some of which can be related to troubleshooting the computing system. Additionally, the end-user can be instructed to calibrate the computer system (or re-calibrate if need be) in a quiet environment in order to avoid disrupting the calibration process. The end-user can also be instructed to calibrate the computer system in a number of different locations having different environmental conditions (such as ambient noise level, temperature, and so forth). The end-user initiated calibration procedure can be used by the end-user in any situation where, for example, unwanted vibrations can be sensed. This can be due to a number of factors such as normal wear and tear affecting the physical response of the computer system, modifying the physical attributes (adding or removing components) of the computer system, and so on. In one scenario, the end user can call up a user interface on the computer system that can then be used to initiate the end user calibration procedure. The resulting calibration data can then be used by the processor to alter the operation of the computer system. In some cases, the physical response of the computer system to the updated calibration data can be subjectively evaluated by the end-user. The subjective evaluation can then form a basis for either running another calibration procedure if the subjective results are deemed unacceptable or retain the updated calibration data otherwise.

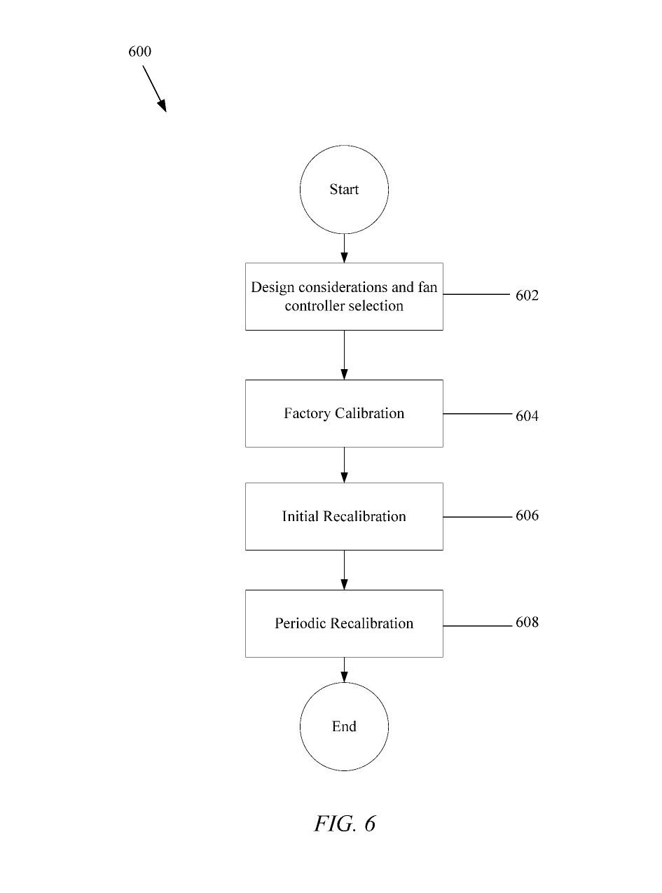

FIG. 6 shows a flow chart describing a process in accordance with the described embodiments. In step 602 cooling fans that are to be used in the design of a computer are characterized using the Campbell Diagrams described in FIG. 2. A number of different fan controller profiles can be tested in an attempt to shift the vibration resonances of the fans as far from the vibration resonances of the computer system as possible. This can minimize or eliminate the amount of notching (shown in FIG. 4) that must be done in regular operations. Where a consistent set of computer system vibration resonances is achieved, an initial Look Up Table can be constructed and applied to the computer system's fan controllers prior to completion of the computer system's assembly. It should be noted that additional Look Up Tables can be used when more than one vibration source could potentially be present. In step 604 computer systems are assembled, tested, and calibrated. In manufacturing lines with low levels of sample variation this step can be used as more of a spot check for quality control, as the designed look-up tables tend to work fairly well. Where there is any significant sample variation each unit can be run through the testing and calibration step. Once the unit is shipped to an end user an initial recalibration step 606 can be accomplished. This can be accomplished during the initial computer setup. Finally step 608, periodic recalibration, can be done at manufacturer or even user-defined intervals appropriate to keep up with any changes that occur to the computer. Periodic recalibrations can also be triggered when the computer detects a hardware reconfiguration such as, for example, the addition of memory or the replacement of a hard drive.

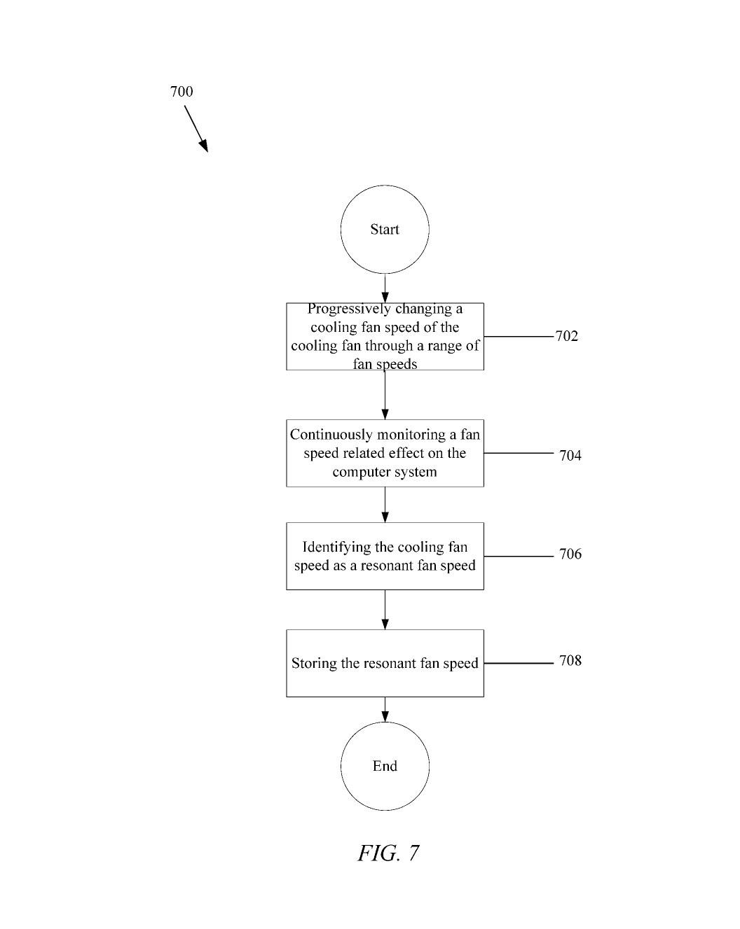

FIG. 7 shows a flowchart detailing process 700 for calibration of an operating state of a component and associated physical response of a system in accordance with the described embodiments. Process 700 can be carried out by performing at least the following operations. At 702, progressively changing an operating state of the component. For example, when the component is a cooling fan, the operating state can refer to a cooling fan speed. In this way, the progressively changing the operating state can relate to changing the cooling fan speed through a range of fan speeds. At 704, continuously monitoring by a sensor a physical response of system. Again using the example of the cooling fan, while the cooling fan speed is being progressively changed, a fan speed related effect (such as a vibration effect or acoustic effect) can be monitored. At 706, a determination is made if the observed physical effect exceeds a pre-determined threshold value indicating at 708 that the associated cooling fan speed coincides with a resonant frequency of the system. The predetermined threshold value will typically be based on assuring a positive user experience. At 710, storing the fan speed associated with the resonant frequency of the system (referred to as a critical fan speed) can be stored in a memory device. In one embodiment, the calibration data can be embodied as a Look Up Table stored in a memory device included in the computer system and/or in an external device such as a vibration tester.

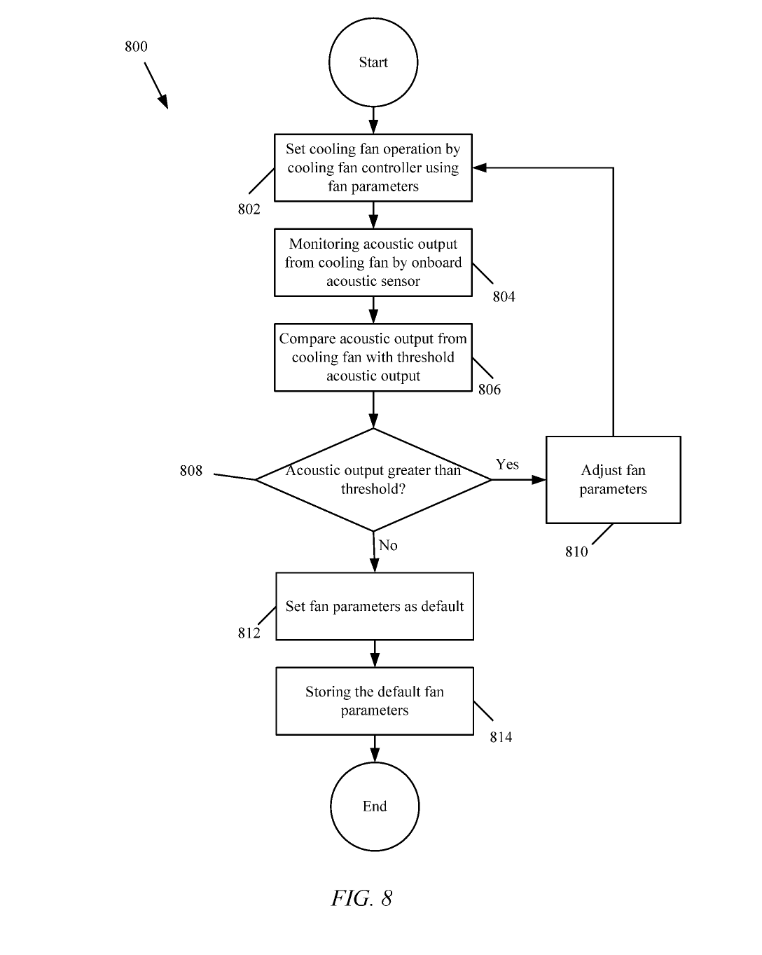

FIG. 8 shows a flowchart detailing process 800 for monitoring in real time a physical response of a computer system to a current operating state of a cooling fan assembly in accordance with the described embodiments. In particular, process 800 can be carried out by operating the cooling fan assembly using a set of cooling fan parameters at 802. At 804, physical response of computer system is monitored by an on board sensor. In one embodiment, an on board sensor can take the form of a piezo-electric sensor that is sensitive to physical displacements. In this way, the piezo-electric sensor can be attached to a housing of the computer system in such a way that any vibration caused by the cooling fan assembly will cause the computer system housing to move which can be detected by the piezo-electric sensor. Other types of sensors can include an accelerometer, acoustic sensors such as a microphone, and so on. In any case, regardless of the type of sensor, or sensors used, the monitored physical response of the computer system is compared to the physical response of the computer system stored in the data storage device for that particular operating state of the cooling fan assembly at 806. If at 908, the comparison indicates that the physical response of the computer system is out of range of what is considered to be acceptable (i.e., monitored vibration is greater than the baseline), then at 910, the calibration data stored in a data storage device is updated.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data in both a volatile as well as non-volatile manner which can thereafter be read by a computer system. Examples of the computer readable medium include read-only memory, HDDs, or solid state memory (such as FLASH). The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for operating a computing system having a mechanical component with at least one rotational aspect and a processor, the mechanical component controlled by the processor, the method comprising:
determining by the processor if the first operating state coincides with a resonant frequency of the computing system; and
preventing the computing system from operating at the resonant frequency by modifying by the processor the first operating state of the mechanical component to a second operating state that avoids the resonant frequency of the computing system.

2. The method as recited in claim 1, the determining comprising:
sensing a physical response of the computing system in accordance with the first operating state of the mechanical component by a sensor, and if the physical response exceeds a threshold level, then the first operating state coincides with the resonant frequency of the computing system.

3. The method as recited in claim 2, when the first operating state coincides with the resonant frequency of the computing system then modifying the first operating state by the processor by accessing resonant frequency avoidance data, the resonant frequency avoidance data including data used by the processor to modify the first operating state of the computing system to the second operating state to avoid the resonant frequency.

4. The method as recited in claim 3, wherein the sensor is selected from a group that includes an accelerometer, an acoustic sensor, and a G-Sensor.

5. The method as recited in claim 4, wherein when the sensor is the acoustic sensor, the determining comprising:
receiving acoustic energy associated with the physical response of the computing system at the acoustic sensor;
determining if the received acoustic energy is greater than a threshold value of acoustic energy;
adjusting at least one operating parameter of the mechanical component when the acoustic energy is greater than the threshold value; otherwise
setting a current operating parameter as a default operating parameter.

6. The method as recited in claim 5, wherein the acoustic sensor is a microphone.

7. The method as recited in claim 1, wherein the sensor is on-board the computing system.

8. The method as recited in claim 3, wherein the mechanical component is a cooling fan assembly comprising a rotor assembly and at least one fan blade arranged to operate at a fan speed as directed by the processor.

9. The method as recited in claim 8, wherein the resonant frequency avoidance data includes a critical fan speed coincident with at the resonant frequency of the computing system and therefore to be avoided.

10. The method as recited in claim 9, wherein the processor alters a current fan speed of the cooling fan assembly to operate at other than the critical fan speed in order to avoid the resonant frequency of the computing system.

11. The method as recited in claim 10, wherein the resonant frequency avoidance data is embodied as a Look Up Table (LUT).

12. The method as recited in claim 11, wherein the LUT is stored in a non-volatile memory on board the computing system.

13. The method as recited in claim 12, wherein the resonant frequency avoidance data embodied in the LUT further comprises temperature dependent resonant frequency avoidance data.

14. The method as recited in claim 12, wherein the resonant frequency avoidance data embodied in the LUT further comprises computing system operating state dependent resonant frequency avoidance data.

15. The method as recited in claim 12, wherein the resonant frequency avoidance data in the LUT further comprises temperature dependent resonant frequency avoidance data.

16. The method as recited in claim 12, wherein the resonant frequency avoidance data in the LUT further comprises beating frequency avoidance data.

17. A computing system, comprising:
a data storage device for storing data;
at least one mechanical component having at least one rotational aspect; and
a processor, the processor arranged to dynamically determine during operation of the computing system a critical resonance frequency for the at least one rotational component using a sensor by:
progressively changing a rotational speed of the rotational aspect through a range of rotational speeds,
using a sensor to monitor the mechanical response of the computing system while the rotational speed is being progressively changed,
identifying any rotational speeds as resonant rotational speeds at which the mechanical response monitored by the sensor exceeds a pre-determined threshold,
storing the resonant rotational speed in the data storage device, and for a period thereafter, the processor avoids operating the at least one mechanical component at any of the identified resonant rotational speeds.

18. The computing system as recited in claim 17, wherein a first rotational component is a cooling fan.

19. The computing system as recited in claim 18, wherein during operation of the computer system, the processor monitors a current operational cooling fan speed of the cooling fan, modifies power supplied to the cooling fan when the current operational cooling fan speed is within a pre-determined value of the resonant fan speed stored in the data storage device, wherein the modification of the power supplied to the cooling fan causes the cooling fan to avoid the resonant fan speed.

20. The computing system as recited in claim 18, wherein the mechanical response is vibration and the sensor is selected from the group that includes a microphone, an accelerometer, and a G-Sensor.

21. The computing system as recited in claim 19, wherein a second rotational component is selected from a group that includes an optical disk drive, a hard disk drive, and another cooling fan.

22. Non-transient computer readable medium for storing computer code executable by a processor in a computer system having at least one rotational component, at least one sensor arranged to detect mechanical vibrations and/or acoustic emissions of the computer system, and a data storage device, the computer readable medium comprising:
computer code for progressively changing a cooling fan speed of the cooling fan through a range of fan speeds;
computer code for continuously monitoring by the at least on onboard sensor while the cooling fan speed is being progressively changed, a fan speed related effect on the computer system;
computer code for identifying the cooling fan speed as a resonant fan speed at which the fan speed related effect on the computer system exceeds a pre-determined threshold;
computer code for storing the resonant fan speed in a data storage device in the computer system; and
computer code for operation the cooling fan at alternate speeds to avoid operation at least one resonant fan speed.

23. The computer readable medium as recited in claim 22, wherein the at least one sensor is selected from the group consisting of a microphone, an accelerometer, and a G-Sensor.

24. The computer readable medium as recited in claim 23, further comprising:
computer code for monitoring a current operational cooling fan speed of the cooling fan; and
computer code for modifying power supplied to the cooling fan when the current operational cooling fan speed is within a pre-determined value of the resonant fan speed stored in the data storage device, wherein the modification of the power supplied to the cooling fan causes the cooling fan to avoid the resonant fan speed.

25. The computer readable medium as recited in claim 24, further comprising:
computer code for receiving data in accordance with an operating state and associated system vibration resonance of rotating components other than the cooling fan disposed within the computer system; and
computer code for determining a computer system resonant fan speed and associated system vibration resonance based upon resonant frequencies of the cooling fan and the rotating components other than the cooling fan.
